(19) United States
(12) Patent Application Publication
(10) Pub. No.: US 2015/0193779 A1
(43) Pub. Date: Jul. 9, 2015

(54) METHOD AND SYSTEM OF MONITORING DRIVER INFORMATION

(71) Applicant: Enzo Elite Enterprises LLC, Coconut Creek, FL (US)

(72) Inventor: Jaysen Oscar Lima, Coconut Creek, FL (US)

(21) Appl. No.: 14/589,289

(22) Filed: Jan. 5, 2015

Related U.S. Application Data
(60) Provisional application No. 61/924,093, filed on Jan. 6, 2014.

(51) Int. Cl. G06Q 30/00

(52) U.S. Cl. CPC G06Q 30/018

(57) ABSTRACT

A method of monitoring driver information is disclosed. The method includes receiving an identification associated with a driver; receiving real-time location information associated with the driver from a location based sensor, and selecting, from a plurality of licensing bureau servers, a licensing bureau server that corresponds to the real-time location information. Driver information associated with the at least one driver is received from the selected licensing bureau server and presented to the driver.

### CROSS-REFERENCE TO RELATED APPLICATION

This application claims priority to U.S. Provisional Patent Application No. 61/924,093 filed Jan. 6, 2014, the entirety of which is incorporated by reference.

### FIELD OF THE INVENTION

The present invention relates generally to driver information monitoring systems, and more particularly relates to methods and systems for monitoring driver license information based on real-time location information.

### BACKGROUND OF THE INVENTION

It is well-known that motor vehicles have become an essential component of modern living. Many individuals own one or more personal motor vehicles. Many businesses utilize motor vehicles for business purposes, such as delivering goods to customers, or transporting employees to perform a service. Motor vehicles are an essential part of emergency response procedures. Fire trucks are used to quickly transport firemen and equipment to an emergency site and ambulances are used to quickly transport individuals to hospitals and provide on-site emergency care. Additionally, ground transportation of goods throughout the United States is a huge industry. The American Trucking Association reports that in 2012, trucks moved 9.4 billion tons of freight, or about 68.5 percent of all freight tonnage transported domestically. According to the U.S. Department of Commerce, motor carriers collected $643 billion in revenue, or about 81 percent of total revenue earned by all domestic transport modes.

In order to achieve proper and safe use of motor vehicles, government's license motor vehicle drivers. These motor vehicle licenses (hereinafter “licenses”) can be suspended, restricted, denied, or withdrawn for any number of reasons, such as: accumulating too many driving points, receiving multiple traffic violations or speeding tickets, receiving a ticket for driving under the influence (DUI), or driving while intoxicated (DWI), failing to appear in court or pay fees, failing to pay child support, failing to pay tolls, not possessing insurance, having a lapsed insurance policy, and the like. Many state government offices may suspend or restrict driver licenses, including the Department of Motor Vehicles, the Secretary of State, the Department of Revenue, and the Motor Vehicle Division.

Florida, a state with approximately 15 million legal drivers, has 2.2 million drivers with suspended, or revoked licenses. Nationally, one study showed that approximately 1 in 10 motor vehicle drivers (hereinafter “drivers”) are driving illegally and about one-third of those drivers are unaware that they are driving illegally. Problematically, many drivers are unknowingly, operating their motor vehicles with an invalid, or restricted license. The penalties for driving with a suspended, or revoked license can include large fines and jail time, with increased sentences for repeat offenders. Additionally, fleet managers and other business owners that employ drivers may be liable for permitting their employee drivers to operate company vehicles with a suspended, revoked, or otherwise invalid license. Unfortunately, for business that employs a large volume of drivers, it is very cumbersome to monitor one or more driver licenses for each employee. This is especially cumbersome for employers who employ long haul truck drivers that that typically travel across multiple state lines for delivery routes and may, therefore, possess driver licenses in multiple states.

Therefore, a need exists to overcome the problems with the prior art as discussed above.

### SUMMARY OF THE INVENTION

The invention provides a method and system of monitoring driver information that overcomes the hereinafore-mentioned disadvantages of the heretofore-known devices and methods of this general type.

With the foregoing and other objects in view, there is provided, in accordance with the invention, a method of monitoring driver information, the method including receiving at least one identification associated with at least one driver; receiving real-time location information associated with the at least one driver from a location based sensor; selecting, from a plurality of licensing bureau servers, a licensing bureau server that corresponds to the real-time location information; and receiving driver information associated with the at least one driver from the selected licensing bureau server.

In accordance with another feature, an embodiment of the present invention includes receiving at least one driver license number associated with the at least one driver.

In accordance with yet another feature, an embodiment of the present invention includes receiving information on whether the at least one driver license number is associated with a valid license.

In accordance with a further feature, an embodiment of the present invention includes receiving the real-time location information associated with the at least one driver from a location based sensor communicatively coupled to a mobile electronic device associated with the at least one driver.

In accordance with a further feature, an embodiment of the present invention includes receiving the real-time location information associated with the at least one driver from a global positioning system (GPS) sensor.

In accordance with another feature, an embodiment of the present invention includes causing the driver information to be presented on a computer display of a mobile electronic device associated with the at least one driver.

In accordance with another feature of the present invention, the identification includes a plurality of identifications, each one of the plurality of identifications corresponding to one of the plurality of licensing bureau servers.

In accordance with yet another feature, an embodiment of the present invention includes selecting the licensing bureau server that corresponds to the real-time location information in real-time while the at least one driver is traveling.

In accordance with a further feature of the present invention, an embodiment includes storing the at least one identification in non-volatile memory; and receiving driver information associated with the at least one driver from the selected licensing bureau server using the at least one identification stored in non-volatile memory.

In accordance with another feature, an embodiment of the present include storing the identification in non-volatile memory; and automatically receiving driver information associated with the at least one driver from the selected licensing bureau server using the at least one identification stored in non-volatile memory.

In accordance with a further feature, an embodiment of the present invention includes storing the identification in non-volatile memory; and periodically receiving driver information associated with the at least one driver from the selected licensing bureau server using the at least one identification stored in non-volatile memory.

In accordance with yet a further feature, an embodiment of the present invention includes a system for monitoring driver information, the system including a plurality of licensing bureau servers communicatively coupled to a network; a processing device communicatively coupled to the network; communicatively coupled to a location based sensor; and operably configured to execute programming instructions. The programming instructions include instructions for receiving at least one identification associated with at least one driver; receiving real-time location information associated with the at least one driver from the location based sensor; selecting, from the plurality of licensing bureau servers, a licensing bureau server that corresponds to the real-time location information; and receiving driver information associated with the at least one driver from the selected licensing bureau server.

In accordance with another feature of the present invention, the identification includes at least one driver license number.

In accordance with yet another feature of the present invention, the programming instructions further include receiving information on whether the at least one driver license number is associated with a valid license.

In accordance with a further feature of the present invention, the location based sensor is formed as a global positioning system (GPS) sensor.

In accordance with yet a further feature of the present invention, the programming instructions further include causing the driver information to be presented on a computer display of a mobile electronic device associated with the at least one driver.

In accordance with another aspect of the present invention, the programming instructions further include selecting the licensing bureau server that corresponds to the real-time location information in real-time while the at least one driver is traveling.

In accordance with another feature, an embodiment of the present invention further includes non-volatile memory communicatively coupled to the processing device; and the programming instructions further include storing the at least one identification in the non-volatile memory; and receiving driver information associated with the at least one driver from the selected licensing bureau server using the at least one identification stored in non-volatile memory.

In accordance with yet another feature, an embodiment of the present invention further includes non-volatile memory communicatively coupled to the processing device; and the programming instructions further include storing the at least one identification in the non-volatile memory; and automatically receiving driver information associated with the at least one driver from the selected licensing bureau server using the at least one identification stored in non-volatile memory.

Although the invention is illustrated and described herein as embodied in a method and system of monitoring driver information, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the motor vehicle. The terms “program,” “software application,” “programming instructions,” and the like as used herein, are defined as a sequence of instructions designed for execution on a computer system. A “program,” “computer program,” “programming instructions,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an exemplary distributed data processing network with a mobile electronic device, a license bureau server, and a driver license monitoring server in accordance with an embodiment of the present invention;

FIG. 2 is a block diagram of a mobile electronic device, in accordance with an embodiment of the present invention;

FIG. 3 is a block diagram of a data processing system that may be implemented as a network device, such as a server, in accordance with an embodiment of the present invention;

FIG. 4 is a process flow chart representing an exemplary method of monitoring driver license information in accordance with the present invention;

FIG. 5 is a screenshot of an exemplary software application at least partially implementing the inventive process, the screenshot depicting a home screen on a user's mobile electronic device in accordance with an embodiment of the present invention;

FIG. 6 is a screenshot from the exemplary software application of FIG. 4 depicting a user interface operable to receive driver identification information in accordance with an embodiment of the present invention;

FIG. 7 is a schematic diagram of a map illustrating a driver's route across state boundaries in accordance with an exemplary embodiment of the present invention; and

FIG. 8 is a screenshot from the exemplary software application of FIG. 4 depicting a user interface displaying driver information in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient method and system for monitoring driver license status/information. Embodiments of the invention provide a software application that receives one or more driver license numbers of one or more individual drivers. In addition, embodiments of the invention provide a system that receives real-time location information associated with a driver's current location and automatically selects a licensing bureau server corresponding to the relevant licensing bureau for the driver's current location. In some embodiments, the software application receives driver license status information for the driver from the relevant licensing bureau server, which driver license status information is then displayed to the driver and/or an interested party, such as a fleet manager. In further embodiments, the driver license numbers are stored in non-volatile memory and the software application automatically and periodically obtains driver license status information using the stored driver license numbers, avoiding the hassle of requiring the user to input the driver license number for each status check.

### Network

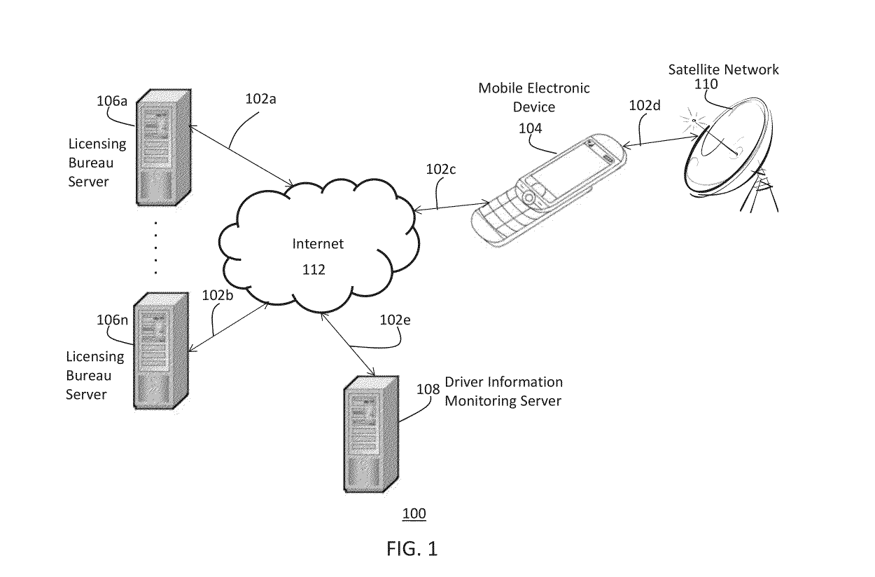

Referring now to FIG. 1, one embodiment of the present invention is shown in a block diagram view. FIG. 1 shows several advantageous features of the present invention, but, as will be described below, the invention can be provided in several shapes, sizes, combinations of features and components, and varying numbers and functions of the components. The first example of a driver information monitoring network 100, as shown in FIG. 1, includes connections 102a-e. The connections 102a-e are the medium used to provide communications links between various devices and computers connected together within the network 100. The connections 102a-e may be wired or wireless connections. A few exemplary wired connections are cable, phone line, and fiber optic. Exemplary wireless connections include radio frequency (RF), infrared radiation (IR) transmission, and satellite transmissions. Many other wired and wireless connections are known in the art and can be used with the present invention.

In the depicted example, the network 100 includes a mobile electronic device 104, a plurality of license bureau servers 106a-n, and a driver information monitoring server 108. Although the exemplary network 100 depicts a single mobile electronic device 104, it is understood that there can be any number of mobile electronic devices 104, associated with any number of drivers, communicatively coupled to the network 100. In one exemplary embodiment, the user is a driver and the driver inputs at least one identification associated with the driver, such as, for example, the driver's license number. In one embodiment, the driver inputs his driver license number via a user input interface, such as a keypad or a touchscreen, on his mobile electronic device 104. In alternative embodiments, the user is an interested party, such as a fleet manager or business owner and the electronic device used to input and send driver license information can be the fleet manager's mobile electronic device, or a non-mobile computing device, such as a personal computer (PC) associated with the business.

The mobile electronic device 104 is communicatively coupled to a satellite network 110 and the Internet 112 via the connections 102d and 102c, respectively. The connection 102d allows the mobile electronic device 104 to receive real-time location information, such as global positioning system (GPS) coordinates, via the satellite network 110. Additionally, the connection 102c allows the mobile electronic device 104 to access one or more of the licensing bureau servers 106a-n via the Internet 112. The Internet 112 represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 100 also may be implemented as a number of different types of networks, such as for example, an Intranet, a local area network (LAN), or a wide area network (WAN). FIG. 1 is intended as an example, and not as an architectural limitation for the present invention.

In one embodiment, the mobile electronic device 104 selects the license bureau server 106a-n that corresponds to the real-time location information. For example, the GPS coordinates may indicate that the mobile electronic device 104 is located within the state of Florida and, by association, the assumption is that the driver is located within the state of Florida. Thereafter, the mobile electronic device 104, or more particularly, the processing device within the mobile electronic device 104, executes programming instructions to request driver information from the licensing bureau within the state of Florida, i.e. the Florida Department of Highway Safety and Motor Vehicles. The licensing bureau servers 106a-n may be communicatively coupled to the Internet 112 via the communication links 102a and 102b.

In one embodiment, the network 100 can include the driver information monitoring server 108, which can operate as a centralized server database that receives driver license information from the mobile electronic devices 104 communicatively coupled to the network 100 and stores the driver license information in non-volatile memory. This driver license information is utilized to obtain driver license status updates automatically and periodically to keep drivers, fleet managers, and/or business owners periodically updated with driver license status, such as whether the license is currently valid, suspended, revoked, pending suspension, or otherwise restricted. The driver information monitoring server 108 can be communicatively coupled to the Internet 112 via the communication link 102e. In some embodiments, the driver license status updates are associated with an account having, for example, a username and a password associated therewith. In such embodiments, the account information, including the username, password, and any other information associated with the accountholder, or driver can be stored at the driver information monitoring server 108.

### Mobile Electronic Device

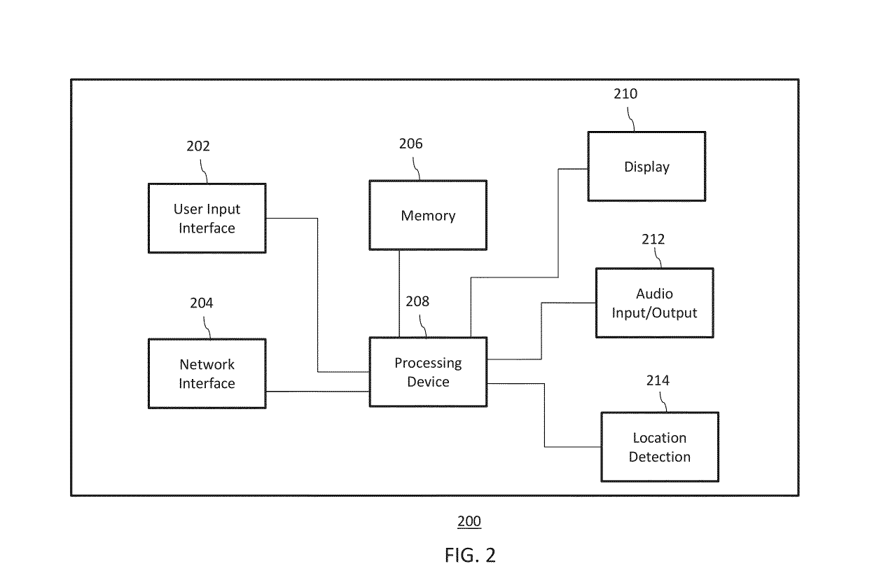

Referring now to FIG. 2, an exemplary mobile electronic device 200 is illustrated in a block diagram. The exemplary mobile electronic device 200 includes a user input interface 202, a network interface 204, memory 206, a processing device 208, a display 210, an audio input/output 212, and a location detection device 214.

The user input interface 202 functions to provide a user a method of providing input to the mobile electronic device 200. The user input interface 202 may also facilitate interaction between the user and the mobile electronic device 200. The user input interface 202 may be a keypad providing a variety of user input operations. For example, the keypad may include alphanumeric keys for allowing entry of alphanumeric information (e.g. telephone numbers, contact information, text, etc.). The user input interface 202 may include special function keys (e.g. a camera shutter button, volume control buttons, back buttons, home button, etc.), navigation and select keys, a pointing device, and the like. Keys, buttons, and/or keypads may be implemented as a touchscreen associated with the display 210. The touchscreen may also provide output or feedback to the user, such as haptic feedback or orientation adjustments of the keypad according to sensor signals received by motion detectors, such as an accelerometer, located within the mobile electronic device 200.

The network interfaces 204 may include one or more network interface cards (NIC) or a network controller. In some embodiments, the network interface 204 may include a personal area network (PAN) interface. The PAN interface may provide the capability for the mobile electronic device 200 to network using a short-range communication protocol, for example, a Bluetooth communication protocol. The PAN interface may permit one mobile electronic device 200 to connect wirelessly to another mobile electronic device 200 via a peer-to-peer connection.

The network interfaces 204 may also include a local area network (LAN) interface. The LAN interface may be, for example, an interface to a wireless LAN, such as a Wi-Fi network. In one embodiment, there is a wireless LAN that provides the mobile electronic device 104 with access to the Internet for receiving the real-time communications therefrom. The range of the LAN interface may generally exceed the range available via the PAN interface. Typically, a connection between two electronic devices via the LAN interface may involve communication through a network router or other intermediary device.

Additionally, the network interfaces 204 may include the capability to connect to a wide area network (WAN) via a WAN interface. The WAN interface may permit a connection to a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

The mobile electronic device 200 may also include a near field communication (NFC) interface. The NFC interface may allow for extremely close range communication at relatively low data rates (e.g., 424 kb/s). The NFC interface may take place via magnetic field induction, allowing the NFC interface to communicate with other NFC interfaces located on other electronic mobile devices 200 or to retrieve information from tags having radio frequency identification (RFID) circuitry. The NFC interface may enable initiation and/or facilitation of data transfer from one mobile electronic device 200 to another electronic device with an extremely close range (e.g. 4 centimeters).

Memory 206 associated with the mobile electronic device 200 may be, for example, one or more buffer, a flash memory, or volatile memory, such as random access memory (RAM). The mobile electronic device 200 may also include non-volatile or non-transitory storage. The non-volatile or non-transitory storage may represent any suitable storage medium, such as a hard disk drive or non-volatile memory, such as flash memory.

The processing device 208 can be, for example, a central processing unit (CPU), a microcontroller, or a microprocessing device, including a “general purpose” microprocessing device or a special purpose microprocessing device. The processing device 208 executes code stored in memory 206 in order to carry out operation/instructions of the mobile electronic device 200. The processing device 208 may provide the processing capability to execute an operating system, run various applications, and provide processing for one or more of the techniques described herein.

The display 210 displays information to the user such as an operating state, time, telephone numbers, various menus, application icons, pull-down menus, and the like. The display 210 may be used to present various images, text, graphics, or videos to the user, such as photographs, mobile television content, Internet webpages, and mobile application interfaces. The display 210 may be any type of suitable display, such as an liquid-crystal display (LCD), a plasma display, a light-emitting diode (LED) display, or the like. In one embodiment, the driver license status information is presented on the display 210 for the user to view.

The mobile electronic device 200 may include audio input and output structures 212, such as a microphone for receiving audio signals from a user and/or a speaker for outputting audio data, such as audio alerts, songs, ringtones, video tracks, voice data received by the mobile electronic device 200 over a cellular network, and the like. The mobile electronic device 200 may also include an audio port for connection to peripheral audio input and output structures, such as a headset, an earpiece, peripheral speakers, or microphones. In one embodiment, the driver license status information is audibly recited to the user via the speakers by, for example, a text-to-speech software that “reads” the text of the license status information and converts the text into spoken digital voice output.

The location detection device 214 may be associated with a global positioning system (GPS) or other location sensing technologies. The mobile electronic device 200 may have a GPS receiver or the like, to determine the location of the mobile electronic device 200. In one embodiment, the mobile electronic device 200 receives real-time location information as to the current location of the driver via a GPS receiver/sensor communicatively coupled to the mobile electronic device 200. In a further embodiment, the mobile electronic device 200 selects a licensing bureau server that corresponds to the real-time location information and requests driver information associated with the driver's license from the selected licensing bureau server.

### Server/Computer

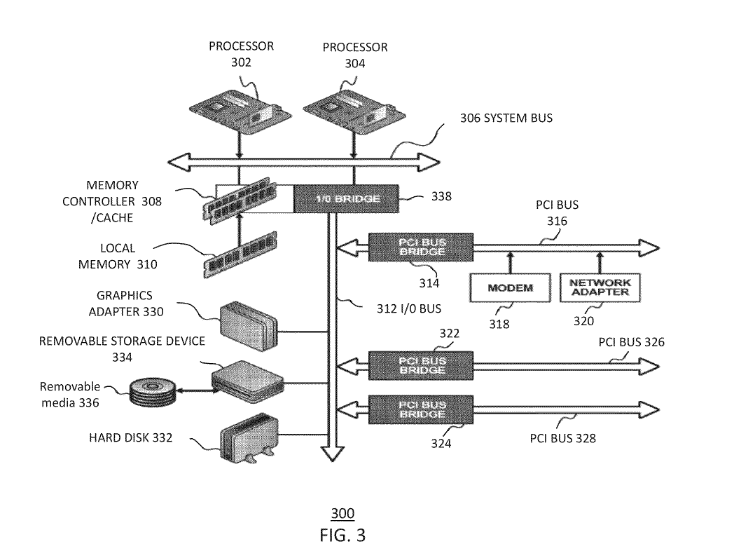

Referring to FIG. 3, a block diagram of a data processing system 300 that may be implemented as a server, such as the licensing bureau server 106 or the driver information monitoring server 108, or implemented as a personal computer, mobile electronic device, recording device, or other computing device coupled to the network 100, as shown in FIG. 1, in accordance with one embodiment of the present invention is presented. The data processing system 300 may be a symmetric multiprocessor (SMP) system including a plurality of processors 302 and 304 connected to system bus 306. Alternatively, a single processor system may be employed. Also, connected to system bus 306 is memory controller/cache 308, which provides an interface to local memory 310. An I/O bus bridge 338 is connected to system bus 306 and provides an interface to I/O bus 312. The memory controller/cache 308 and I/O bus bridge 338 may be integrated as depicted. The processor 302 or 304 in conjunction with memory controller 308 controls what data is stored in memory 310. The processor 302 and/or 304 and memory controller 308 can serve as a data counter for counting the rate of data flow to the memory 310 or from the memory 310 and can also count the total volume of data accessed to or from the memory 310. The processor 302 or 304 can also work in conjunction with any other memory device or storage location.

Peripheral component interconnect (PCI) bus bridge 314 connected to I/O bus 312 provides an interface to PCI local bus 316. A number of modems 318, or wireless cards, may be connected to PCI bus 316. Typical PCI bus implementations will support four PCI expansion slots or add-in connectors. PCI includes, but is not necessarily limited to, PCI-X and PCI Express components. Communications links to the network of computers in FIGS. 1 and 2 may be provided through the modem 318 and network adapter 320 connected to PCI local bus 316 through add-in boards.

Additional PCI bus bridges 322 and 324 provide interfaces for additional PCI buses 326 and 328, from which additional modems or network adapters may be supported. In this manner, the data processing system 300 allows connections to a multiple network of computers. A graphics adapter 330 and hard disk 332 may also be connected to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The processes explained in detail herein can be embodied in a computer program. Computer programs (also called computer control logic) are stored in memory such as main memory 310, removable storage drive 334, removable media 336, hard disk 332, and signals. Such computer programs, when executed, enable the computer system to perform the features of the present invention as discussed herein. In particular, the computer programs, when executed, cause the processor 302 and/or 304 to perform all, or part of the features of the driver information monitoring system.

In this document, the terms “computer program medium,” “computer usable medium,” and “computer readable medium” are used to generally refer to media such as main memory 310, removable storage drive 334, removable media 336, hard disk 332, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer/programming instructions, between computer systems. Furthermore, the computer readable medium may comprise computer readable information in a transitory state medium such as a network link and/or a network interface, including a wired or wireless network, that allows a computer to read such computer readable information.

### Driver Information Monitoring Process

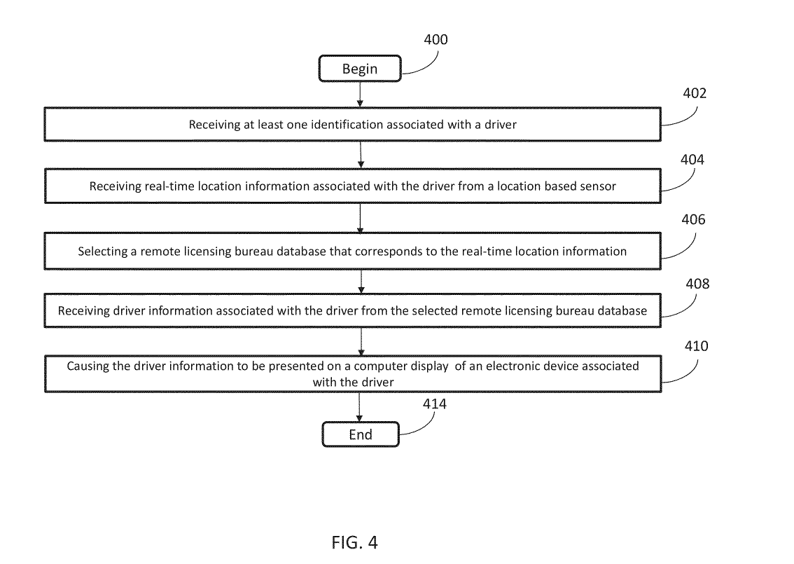

The above-described hardware is useful for implementing embodiments of the present invention, which facilitate monitoring of driver license status information via the network 100. FIG. 4 illustrates a process flow of one embodiment of the present invention. The process flow provides exemplary steps for carrying out an embodiment of the present invention. The invention, however, is not limited to the number or order of steps shown in FIG. 4.

The process will be described in conjunction with the process flow chart of FIG. 4 and the network block diagram of FIG. 1. The process flow starts at step 400 and moves directly to step 402 where the mobile electronic device 104 receives at least one identification associated with at least one driver. As used herein, the term “identification” is defined something that identifies the driver, such as a driver license number, a social security number, a first and last name, and the like. In a preferred embodiment, the identification is a driver license number. As is generally known, a driver license number is a unique alphanumeric code including numbers and/or letters associated with a state issued driver license. The driver license can be associated with any type of driver license, such as a commercial driver license or a non-commercial driver license, in any class and issued in any state's licensing bureau.

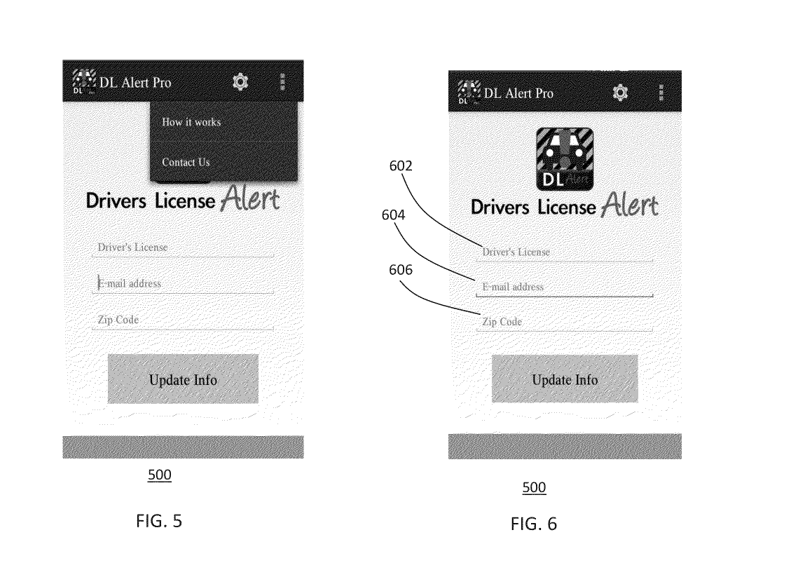

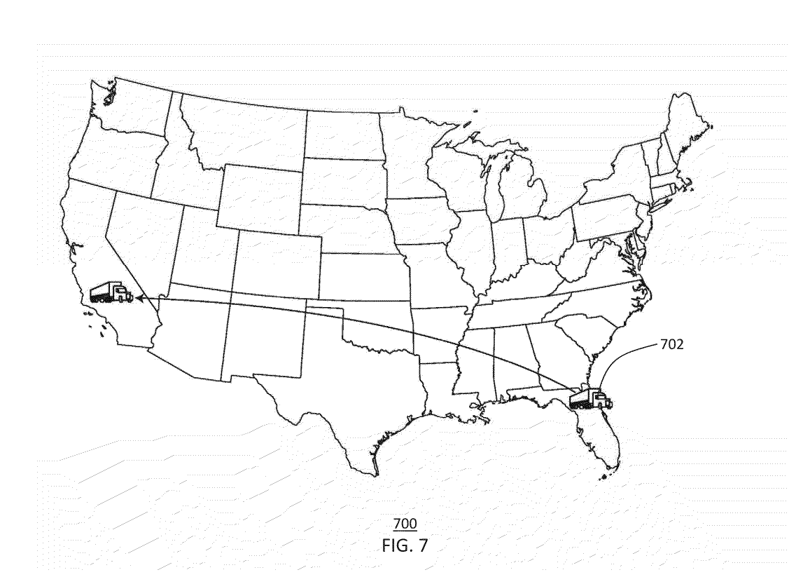

Referring to FIGS. 5-6, in one embodiment, where the process is implemented as a mobile device application, the driver can be presented with a home screen 500. A screenshot of an exemplary home screen 500 is illustrated in FIGS. 5 and 6. The exemplary home screen 500 can include one or more icons or buttons that the driver can select in order to be presented with another user interface screen. In one embodiment, the icons/buttons can include links to a screen that will explain how the mobile application works, and various social networking websites that can allow the driver to post or comment about the drive's status. In another embodiment, the home screen 500 can include an identification input field 602, where the driver can input his or her identification, such as the driver's license number. In some embodiments, the home screen 500 can include a contact information field 604, where the driver can input his or her contact information, such as an email address. In another embodiment, the driver can input a cellular telephone number associated with his mobile electronic device 104 to receive push notification, text messages, or other communication formats to communication the driver's license status. In a further embodiment, the home screen 500 can include a location field 606, where the driver can input location information, such as, for example, a zipcode associated with an area where the driver either resides or travels frequently. In yet another embodiment there can be provided a log-in screen, where the driver logs-in with his or her username and/or password, prior to allowing the driver to query his or her status. In one embodiment, the driver's information (e.g. driver's license number, email address, and zipcode) are associated with an account and stored in non-volatile memory on, for example, the driver information monitoring server 108, so that the driver is not required to input his or her identification each time the driver's license status is desired. In this embodiment, the driver may merely request the driver's license status and the mobile device application is able to retrieve the pre-stored identification corresponding to the driver's location information and automatically present the driver's license status to the driver via the display 210 of the mobile electronic device 200. This is a preferred embodiment, as it eliminates the additional steps of having to input identification information each time the driver desires a driver's license status check, which is very inconvenient and inefficient. In some embodiments, when the driver first inputs his or her driver's license number, the mobile electronic device 104 can automatically determine the licensing bureau server 106a-n associated with the driver's license number and can save both the driver's license number and an identification of the corresponding licensing bureau server 106a-n.

In other embodiments, the identification can be other types of identifying information, such as a social security number. In another embodiment, the mobile electronic device 104 can receive a plurality of identifications. In a further embodiment, each one of the plurality of identifications corresponds to one of the plurality of licensing bureau servers 106a-n. For example, a driver may possess a plurality of driver licenses, such as a non-commercial driver license for driving a personal vehicle and a plurality of commercial driver licenses (CDLs) in multiple states for commercial transportation of goods through multiple states. Accordingly, the driver can input each of the plurality of driver license numbers into the mobile electronic device 104 to receive status from each of the relevant licensing bureau servers 106a-n. As is generally known, each state within the U.S. operates a licensing bureau, also referred to as the state's department of motor vehicles that is responsible for issuing and managing the state's driver licenses. In one embodiment, each of the driver license numbers can be stored in non-volatile memory so that status can be requested by using the stored driver license numbers, without requiring the driver to re-input the numbers each time a status check is desired, as discussed herein above. As used herein, the term “non-volatile memory” is intended to indicate any computer memory or computer storage that stores information even without power being applied, such as read-only memory (ROM), programmable read-only memory (PROM), electrically erasable programmable read-only memory (EEPROM), hard disk drives, and flash memory. In a further embodiment, the driver license numbers and any other identification information associated with the driver is stored in non-volatile memory on the driver information monitoring server 108.

With reference again to FIG. 4, in step 404, the mobile electronic device 104 receives real-time location information associated with the driver from a location based sensor. As used herein, the term “real-time” is intended to indicate information that is received and processed relatively quickly to provide substantially immediate feedback. In some embodiments, the feedback is processed on the order of seconds. In other embodiments, the feedback is processed on the order of minutes. For example, drivers desiring to receive driver license status updates while driving may travel across multiple state lines within a single twenty-four hour period, as illustrated in FIG. 7. Therefore, such drivers would want to receive the driver license status relevant to the particular state they may be currently located in at any point during the day as they are traveling across state boundaries. In the exemplary embodiment, FIG. 7 shows a schematic diagram of a map 700, illustrating a motor vehicle 702 traveling from Florida to California, crossing through the states of Alabama, Mississippi, Arkansas, Oklahoma, Texas, New Mexico and Arizona, in the span of approximately two days. Embodiments of the present invention allow the driver, or the driver's fleet manager, to receive driver status information from licensing bureau servers 106a-n associated with each state, in real-time, as the driver approaches or crosses state boundaries. This can save drivers and fleet managers from the potential liability and costs associated with driving with an expired, suspended, restricted, or otherwise invalid driver license. As discussed above, one study revealed that 1 out of every 10 driver's is driving illegally and a third of those drivers are completely unaware that their license is currently invalid. The consequences for driving without a valid driver's license can include jail time, fines, increased driver's insurance rates, a mandatory court appearance, associated attorney fees, loss of income associated therewith, and the like. In the case of transportation industry drivers, e.g. long haul truck drivers, the consequences can also include loss of or damage to cargo (particularly temperature sensitive cargo), delayed delivery of goods, and the costs associated therewith, which can be very high. Accordingly, the mobile electronic device 104 can utilize the most current location data to pull information from the correct licensing bureau server 106a-n to provide real-time driver license status updates corresponding to the driver's current location.

The real-time location information can be any location information, such as, for example, GPS coordinates, latitude and longitude coordinates, or any other location information. The location based sensor can be any device that detects a driver's location, such as a GPS sensor. In one embodiment, the real-time location information is received from the location based sensor, which is communicatively coupled to the mobile electronic device 104 and the mobile electronic device 104 is associated with the driver. As is generally known, most individuals carry certain mobile electronic devices, such as smarphones or computer tablets, with them wherever they go; therefore, it can safely be presumed that the location of the mobile electronic device 104 is also the location of the driver.

At step 406, the mobile electronic device 104 selects, from the plurality of licensing bureau servers, a licensing bureau server 106a-n that corresponds to the real-time location information. More particularly, the processing device 208 executes programming instructions stored in memory 206 (FIG. 2), which cause the mobile electronic device 104 to perform features described herein, such as selecting the licensing bureau server 106a-n that corresponds to the real-time location information. In one embodiment, the mobile electronic device 104 determines which state within the U.S. corresponds to the GPS data from the GPS sensor in the mobile electronic device 104. The GPS data is likely in a raw data numerical format, which requires processing to determine which state the GPS data corresponds to. For example, GPS coordinates can include latitude and longitude coordinates. In one embodiment, the mobile electronic device 104 includes programming instructions to convert this coordinate data into an identification of a state so that the identified state's licensing bureau server 106a-n can be queried for driver license status. In one embodiment, the mobile electronic device 104 selects the licensing bureau server 106a-n that corresponds to the real-time location information in real-time, while the driver is traveling across state lines or boundaries. This is particularly advantageous for long haul truck drivers, or other drivers that frequently travel across multiple state lines within a relatively short period of time, and on a regular basis.

At step 408, the mobile electronic device 104 receives driver information associated with the driver from the selected licensing bureau server 106a-n. As used herein, the term “driver information” is intended to indicate any information associated with a driver, such as, for example, whether the driver's license is valid, types of licenses held and not held by the driver, restrictions on the driver's license, and other types of vehicles that the driver's license authorizes the driver to operate, etc. In one embodiment, the driver information includes whether the driver license number is associated with a valid license. As used herein, the term “valid license” is intended to indicate a license that is not expired, not suspended, not revoked, and not otherwise restricted in a manner that would render the driver's vehicular use/operation illegal for his intended purposes. In a preferred embodiment, the driver information is received from the selected licensing bureau server 106a-n using the identification stored in non-volatile memory. The non-volatile memory can be the non-volatile memory 206 of the mobile electronic device 200 (FIG. 2), or non-volatile memory of the driver information monitoring server 108. In one embodiment, the processing device 208 of the mobile electronic device 200 retrieves the identification from the non-volatile memory 206 and then communicates the identification to the selected licensing bureau server 106a-n, which selected licensing bureau server 106a-n then retrieves the driver information associated with the identification and subsequently sends the driver information to the mobile electronic device 200 to be presented to the driver via the display 210.

In one embodiment, the mobile electronic device 104 automatically receives driver information associated with the driver from the selected licensing bureau server 106a-n using the identification stored in non-volatile memory. For example, the driver may indicate in a settings menu a request that the driver information should be queried automatically, i.e. without a user initiating the request, anytime the driver approaches a state border. In another embodiment, the driver may indicate in the settings menu that the driver information should be automatically received anytime a sensor communicatively coupled to the mobile electronic device 200 detects that the driver is moving at a speed indicating a likelihood that the driver is driving a motor vehicle. For example, when the sensor detects that the mobile electronic device 200 is accelerating or traveling at more than 25 miles per hour, the driver information is automatically requested from the selected licensing bureau server 106a-n and received by the mobile electronic device 104. In one embodiment, the mobile electronic device 104 first queries whether the driver desires to receive driver information and if the driver answers yes, the drive information is automatically requested from the selected licensing bureau server 106a-n. In yet another embodiment, the driver may receive driver information periodically. For example, the driver may indicate in the settings menu that the driver information should be received periodically, once per month, one per year, or the like. In one embodiment, a computer associated with a business owner, or fleet manager queries and/or receives driver information associated with employee, or independent contractor drivers. In a further embodiment, the business owner, or fleet manager receives the driver information upon request or, alternatively, automatically or periodically, as discussed above. This embodiment advantageously allows fleet managers of a large number of motor vehicles to manage a multitude of drivers conveniently and quickly.

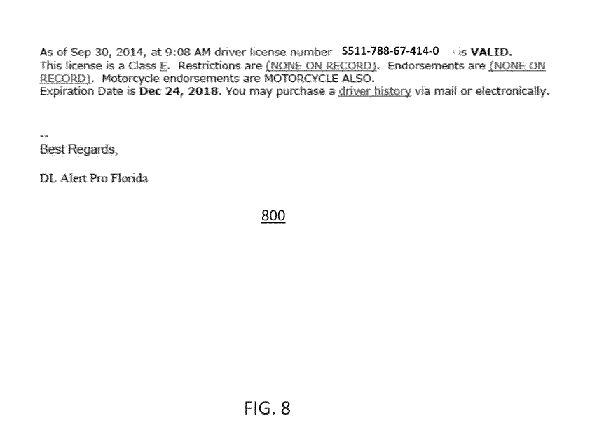

At step 410 (FIG. 4), the mobile electronic device 200 (FIG. 2) causes the driver information to be presented on a computer display. In one embodiment, the computer display is the display 210 (FIG. 2) of the mobile electronic device 200 associated with the driver. In another embodiment, the computer display is a display associated with a business owner, or a fleet manager responsible for monitoring employee, or independent contractor drivers. FIG. 8 presents a screenshot of an exemplary driver status message 800. In the exemplary driver status message 800, the date and time associated with the driver information is presented along with the driver license number. Additionally, the driver information includes status that the driver license is valid. The driver information also includes which classes the license pertains to as well as motorcycle endorsement information and the license expiration date. In some embodiments, the driver information can also include vehicle registration information for vehicles associated with the driver. In some embodiments, the driver status message 800 includes a button, an icon, or a link to allow the driver to request and view driver information associated with yet another driver license number, or other identification. The other driver license number or identification can be associated with another licensing bureau server 106a-n. In some embodiments, the driver status message 800 can be formed as an email message. In other embodiments, the driver status message 800 can be formed as a push notification on the mobile electronic device 200. In yet further embodiments, the driver status message 800 can be formed as other visual, audio, or tactile messages indicating driver license status. The process ends at step 414.

A method and system of monitoring driver license status information has been disclosed that provides for receiving one or more driver license numbers associated with one or more drivers, and receiving real-time location information associated with the driver's current location. Embodiments of the invention provide for automatically selecting a licensing bureau server corresponding to the driver's current location. Embodiments of the invention allow drivers to ensure that they are not driving illegally, thereby avoiding any costs and hassles associated therewith. Other embodiments allow fleet managers and business owners to monitor driver license statuses of a plurality of employee, or independent contractor drivers to reduce any liability and costs associated with such drivers driving illegally on behalf of the business.

What is claimed is:

1. A method of monitoring driver information, the method comprising:
receiving at least one identification associated with at least one driver;
receiving real-time location information associated with the at least one driver from a location based sensor;
selecting, from a plurality of licensing bureau servers, a licensing bureau server that corresponds to the real-time location information; and
receiving driver information associated with the at least one driver from the selected licensing bureau server.

2. The method in accordance with claim 1, wherein:
receiving at least one identification further includes receiving at least one driver license number associated with the at least one driver.

3. The method in accordance with claim 2, wherein:
receiving driver information further includes receiving information on whether the at least one driver license number is associated with a valid license.

4. The method in accordance with claim 1, wherein:
receiving the real-time location information further includes receiving the real-time location information associated with the at least one driver from a location based sensor communicatively coupled to a mobile electronic device associated with the at least one driver.

5. The method in accordance with claim 1, wherein:
receiving the real-time location information further includes receiving the real-time location information associated with the at least one driver from a global positioning system (GPS) sensor.

6. The method in accordance with claim 1, further comprising:
causing the driver information to be presented on a computer display of a mobile electronic device associated with the at least one driver.

7. The method in accordance with claim 1, wherein:
the at least one identification includes a plurality of identifications, each one of the plurality of identifications corresponding to one of the plurality of licensing bureau servers.

8. The method in accordance with claim 1, wherein:
selecting the licensing bureau server further comprises selecting the licensing bureau server that corresponds to the real-time location information in real-time while the at least one driver is traveling.

9. The method in accordance with claim 1, further comprising:
storing the at least one identification in non-volatile memory; and
receiving driver information associated with the at least one driver from the selected licensing bureau server using the at least one identification stored in non-volatile memory.

10. The method in accordance with claim 1, further comprising:
storing the at least one identification in non-volatile memory; and
automatically receiving driver information associated with the at least one driver from the selected licensing bureau server using the at least one identification stored in non-volatile memory.

11. The method in accordance with claim 1, further comprising:
storing the at least one identification in non-volatile memory; and
periodically receiving driver information associated with the at least one driver from the selected licensing bureau server using the at least one identification stored in non-volatile memory.

12. A system for monitoring driver information, the system comprising:
a plurality of licensing bureau servers communicatively coupled to a network;
a processing device:
communicatively coupled to the network;
communicatively coupled to a location based sensor; and
operably configured to execute programming instructions, the programming instructions comprising:
receiving at least one identification associated with at least one driver;
receiving real-time location information associated with the at least one driver from the location based sensor;
selecting, from the plurality of licensing bureau servers, a licensing bureau server that corresponds to the real-time location information; and
receiving driver information associated with the at least one driver from the selected licensing bureau server.

13. The system in accordance with claim 12, wherein:
the at least one identification includes at least one driver license number.

14. The system in accordance with claim 13, wherein the programming instructions further include:
receiving information on whether the at least one driver license number is associated with a valid license.

15. The system in accordance with claim 12, wherein:
the location based sensor is formed as a global positioning system (GPS) sensor.

16. The system in accordance with claim 12, wherein the programming instructions further include:
causing the driver information to be presented on a computer display of a mobile electronic device associated with the at least one driver.

17. The system in accordance with claim 12, wherein:
the at least one identification includes a plurality of identifications, each one of the plurality of identifications corresponding to one of the plurality of licensing bureau servers.

18. The system in accordance with claim 12, wherein the programming instructions further include:
selecting the licensing bureau server that corresponds to the real-time location information in real-time while the at least one driver is traveling.

19. The system in accordance with claim 12, further comprising:
non-volatile memory communicatively coupled to the processing device; and
the programming instructions further including:
storing the at least one identification in the non-volatile memory; and
receiving driver information associated with the at least one driver from the selected licensing bureau server using the at least one identification stored in non-volatile memory.

20. The system in accordance with claim 12, further comprising:
non-volatile memory communicatively coupled to the processing device; and
the programming instructions further including:
storing the at least one identification in the non-volatile memory; and
automatically receiving driver information associated with the at least one driver from the selected licensing bureau server using the at least one identification stored in non-volatile memory.
